(19) United States
(12) Patent Application Publication
(10) Pub. No.: US 2019/0264725 A1
(43) Pub. Date: Aug. 29, 2019

(54) REMOVABLE PUSH-ON FASTENER

(71) Applicant: Newfrey LLC, New Britain, CT (US)

(72) Inventor: Adam A. FORTI, Berkley, MI (US)

(73) Assignee: Newfrey LLC, New Britain, CT (US)

(21) Appl. No.: 15/906,879

(22) Filed: Feb. 27, 2018

(51) Int. Cl. F16B 37/08; F16B 37/04; F16B 5/02

(52) U.S. Cl. CPC F16B 37/0842; F16B 37/02; F16B 5/0208; F16B 37/043

(57) ABSTRACT

First and second apertures can extend through corresponding first and second walls that define a cavity therebetween. Each aperture can have a stud retention zone and a stud release zone laterally spaced from each other, and the corresponding zones of each aperture can be axially aligned with each other. Spring retention fingers can extend outwardly from the first wall and into the first aperture. The spring retention fingers can deflect to pass over threads of the stud in an axial stud insertion direction and can engage the threads to prevent removal of the stud in an opposite stud removal direction when the stud is in the stud retention zone. The spring retention fingers can be designed to allow removal of the stud from the apertures when the stud is in the release zones. The main body can fully enclose the entire periphery of each of the first and second apertures.

### FIELD

The present disclosure relates to removable push-on fasteners.

### BACKGROUND

This section provides background information related to the present disclosure which is not necessarily prior art.

Push-on spring retention fasteners or clips can offer several advantages in joining components together. For example, such a push-on fastener can be pre-assembled with a first component at a location away from the assembly line in which the first component is joined to a stud extending from a second component. Thus, all that is required to join the first and second component together on the assembly line is a single-step, tool-free operation in which the push-on fastener is simply pushed axially onto the stud.

Such push-on spring retention fasteners or clips, however, are typically not so simple to remove. For example, the stud typically must be typically unscrewed from the fastener clip. When the stud is welded or otherwise rotationally fixed relative to the joined components such and unscrewing operation is generally not possible. Thus, damage to such a push-on spring retention clip fastener and the joined components is likely to occur in attempting to separate the components.

Structural rigidity of such push-on spring retention clip fasteners is also important. For example, structural rigidity can be important to facilitate the fastener being easily and properly clipped onto the first component, and also being retained in proper position relative thereto. As another example, structural rigidity can be important to helping insure the spring retention fingers effectively engage and retain the annular protrusions or threads of the stud.

### SUMMARY

This section provides a general summary of the disclosure, and is not a comprehensive disclosure of its full scope or all of its features.

In accordance with one aspect of the present disclosure, a removable push-on fastener can be provided for coupling a first component having a component aperture therethrough with a stud extending from a second component through the component aperture and having at least one annular protrusion along a free end of the stud. The removable push-on fastener can include a U-shaped sheet metal main body having a first wall and a second wall extending from a central bend, forming a first component cavity extending in a plane between the first wall and the second wall. A first aperture can extend through the first wall, and the first aperture can have a first stud retention zone and a first stud release zone laterally spaced from each other within the first aperture. A plurality of spring retention fingers can extend outwardly from the first wall and into the first aperture. The spring retention fingers can be designed to deflect to pass over the annular protrusion in a stud insertion direction that extends axially. A distal end of the spring retention fingers can be designed to engage the annular protrusion to prevent removal of the stud from the first aperture in a stud removal direction that is opposite the stud insertion direction when the stud is in the stud retention zone. The spring retention fingers can be designed to allow removal of the stud from the first aperture when the stud is in the release zone. A second aperture can extend through the second wall. The second aperture can have a second stud retention zone axially that is aligned with the first stud retention zone of the first aperture, and the second aperture can have a second stud release zone that is axially aligned with the first stud release zone of the first aperture. In addition, the main body can fully enclose the entire periphery of each of the first aperture and the second aperture.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an upper exploded perspective view of example components of a coupling assembly, including an exemplary removable push-on fastener in accordance with the present disclosure.

FIG. 2 is a lower exploded perspective view of the example components of FIG. 1.

FIG. 3 is an upper perspective view of the exemplary removable push-on fastener mounted to a first component of FIG. 1 in a retention position.

FIG. 4 is a lower perspective view of the example components of FIG. 3.

FIG. 5 is an upper perspective view of example components of FIG. 1 assembled together in retained or coupled configuration.

FIG. 6 is an upper perspective view similar to FIG. 5, but with the removable push-on fastener shown in a release position.

FIG. 7 is an upper perspective view of the exemplary removable push-on fastener mounted to a first component of FIG. 1 in a release position.

FIG. 8 is a lower perspective view of the example components of FIG. 7.

FIG. 9 is an upper perspective view of the exemplary removable push-on fastener of FIG. 1.

FIG. 10 is a top plan view of the exemplary removable push-on fastener of FIG. 1, in which background features beyond those being referenced by number are shown in broken lines.

FIG. 11 is a bottom plan view of the exemplary removable push-on fastener of FIG. 1, in which background features beyond those being referenced by number are shown in broken lines.

FIG. 12 is an upper perspective view of another example of a removable push-on fastener in accordance with the present disclosure.

FIG. 13 is an upper perspective view of another example of a removable push-on fastener in accordance with the present disclosure.

FIG. 14 is an upper perspective view of another example of a removable push-on fastener in accordance with the present disclosure.

FIG. 15 is an upper perspective view of another example of a removable push-on fastener in accordance with the present disclosure.

Corresponding reference numerals indicate corresponding parts throughout the several views of the drawings.

### DETAILED DESCRIPTION

Example embodiments will now be described more fully with reference to the accompanying drawings.

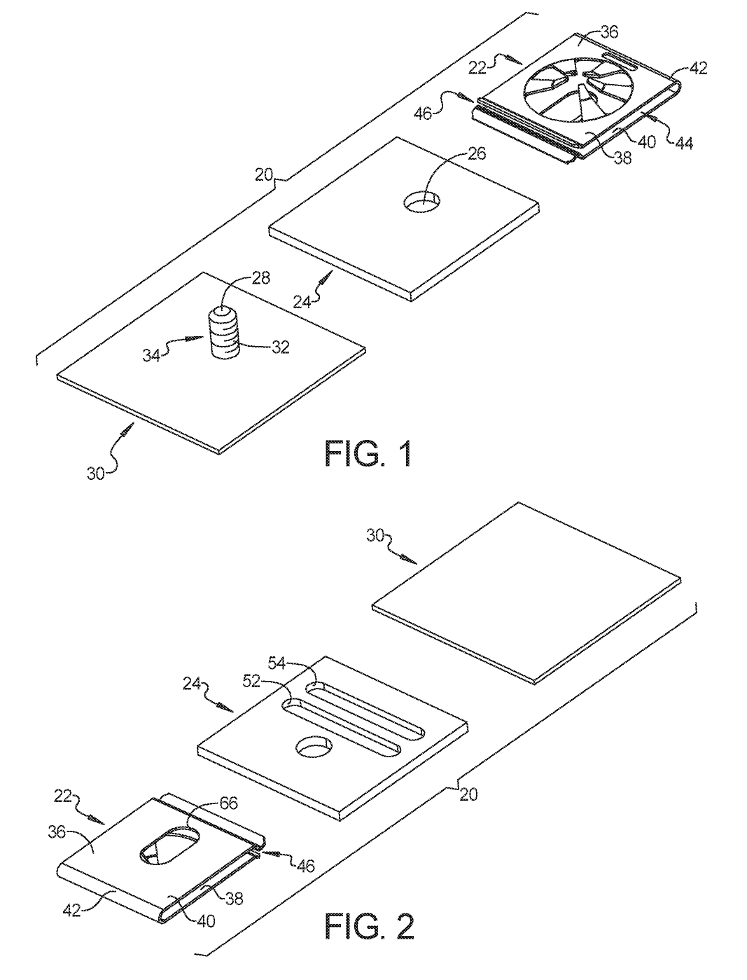

FIGS. 1-9 illustrate example components of a coupling assembly 20 including an exemplary removable push-on fastener 22 in accordance with the present disclosure. The coupling assembly 20 can include a first component 24 having a component aperture 26 therethrough. In some cases, the first component 24 can be a panel as illustrated, in whole or in part. A stud 28 can extend from the second component 30. In some examples, the stud 28 can be integrally formed or singularly molded together with the second component 30, or the stud 28 can be a separate component that is welded to or otherwise integrated with the second component 30, or the stud 28 can be threaded through a corresponding threaded opening (not shown) of the second component 30, or the stud 28 can simply extend through a non-threaded (not shown) opening of the second component 30.

The stud 28 has at least one annular protrusion 32 along a free end 34 of the stud 28. In the illustrated example, the at least one protrusion 32 is in the form of a series of annular protrusions 32 extending along the free end 34 of the stud 28. The annular protrusions 32 of such a series can be regularly or irregularly spaced from each other. As in this example, a series of regularly spaced annular protrusions 32 can be provided by screw threads 32. In some cases, the second component 30, like the first component 24, can be a panel as illustrated, in whole or in part.

As in this example, the removable push-on fastener 22 can have a U-shaped sheet main body 36 that includes a first wall 38 and a second wall 40 extending from a central bend 42. As in the illustrated example, the main body 36 can be made of metal, such as spring steel. Another example main body 36 material that may be suitable in some cases, is plastic. A first component cavity 44 that extends in a plane P can be formed between the first wall 38 and the second wall 40. The first component cavity 44 can have an insertion end 46, which can be opposite the central bend 42. An outwardly angled surface 48 can extend from the first wall 38, the second wall 40, or both. Such outwardly angled surface 48 can be designed to facilitate insertion of the first component 24 into the first component cavity 44 of the removable retention fastener 22 through the insertion end 46. As in this example, the main body 36 can have an overall rectangular shape in plan view, but other shapes are possible.

The main body 36 can include an inwardly extending protrusion 50. As in this example, the inwardly extending protrusion 50 can extend from the second wall 40 of the main body 36 and can be located at or adjacent the insertion end 46 of the removable retention fastener 22. Such an inwardly extending protrusion 50 can be designed to engage a release recess 52 of the first component 24, a retention recess 54 of the first component 24, or both as discussed below. As illustrated, the outwardly angled surface 48 can extend from such an inwardly extending protrusion 50.

A first aperture 56 can extend through the first wall 38 and the first wall 38 of the main body 36 can fully enclose the first aperture 56. A first stud retention zone 58 and a first stud release zone 60 are laterally spaced from each other within the first aperture 56. In other words, the first stud retention zone 58 and a first stud release zone 60 are spaced from each other in a direction that is aligned with the plane P. A plurality of spring retention fingers 62 can extend outwardly from the first wall 38 and into the first aperture 56. The spring retention fingers 62 can be designed to deflect to pass over the annular protrusions 32 in a stud insertion direction that is extends axially. In other words, the stud insertion direction extends essentially perpendicular to, or normal to, the plane P.

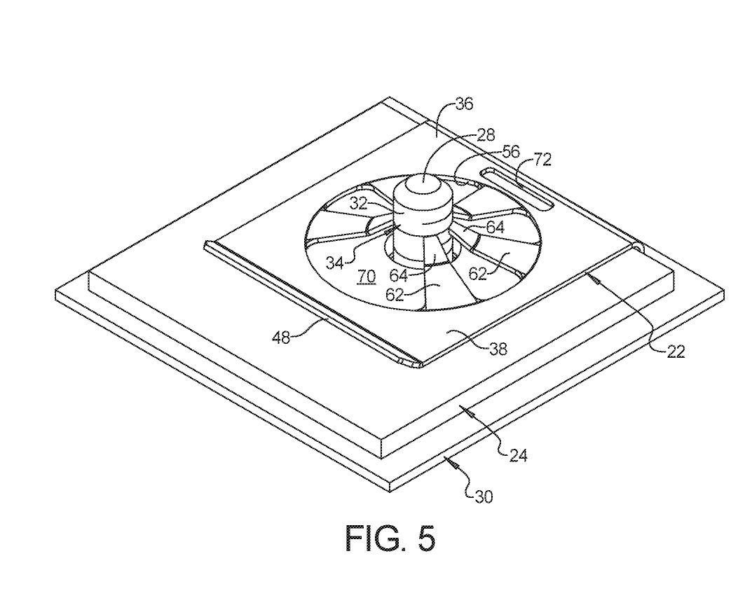

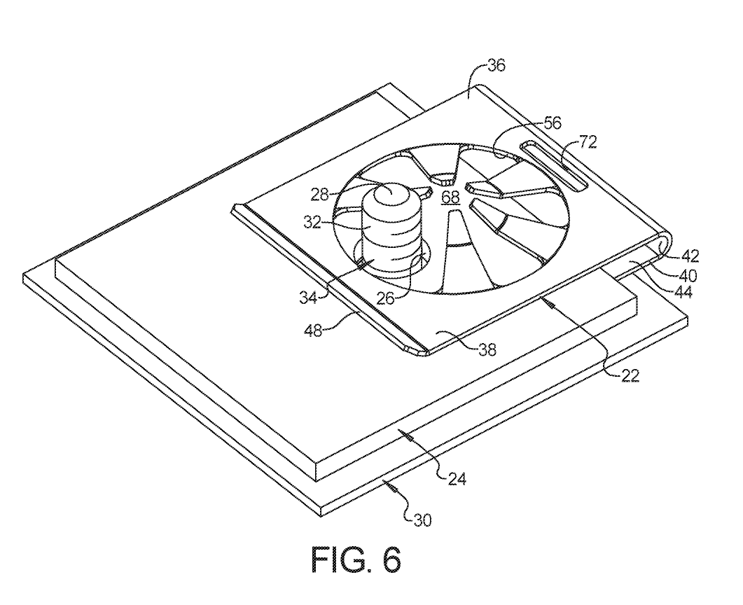

The distal end 64 of the spring retention fingers 62 can be designed to engage the annular protrusions or threads 32 to prevent removal of the stud 28 from the first aperture 56 in a stud removal direction that is opposite the stud insertion direction when the stud 28 is in the stud retention zone 58 (shown in FIG. 5). The distal end 64 of the spring retention fingers 62 can be designed to allow removal of the stud 28 from the first aperture 56 when the stud 28 is in the release zone 60 (shown in FIG. 6). The stud insertion and removal directions and other axial directions can also be aligned with the central axis of the stud 28. As in this example, the first aperture 56, the first stud release zone 60, or both can have an overall circular shape in plan view, but other shapes are possible.

As in this example, the interval, distance or spacing between the adjacent pair of spring retention fingers 62 across the first stud release zone 60 from each other can be greater than that of each interval, distance or spacing between the remaining pairs of adjacent spring retention fingers 62. The remaining pairs of adjacent spring retention fingers 62 can all be provided at a common interval or have a common distance or spacing between them. Also as in this example, the interval, distance or spacing between the adjacent pair of spring retention fingers 62 across the first stud release zone 60 from each other can be twice that of a common corresponding interval, distance or spacing between the remaining pairs of adjacent spring retention fingers 62. Also as in this example, the fastener can have a total of five spring retention fingers 62 and the interval, distance or spacing between the adjacent pair of spring retention fingers 62 across the first stud release zone 60 from each other can be 120 degrees, and a common corresponding interval, distance, or spacing between the remaining pairs of adjacent spring retention fingers 62 can be 60 degrees. In other examples, the spring retention fingers 62 can have different combinations of lengths, widths, shapes, angles, and profiles, etc. from each other.

A second aperture 66 can extend through the second wall 40 of the main body 36 and the second wall 40 of the main body 36 can fully enclose the second aperture 66. The second aperture 66 can have a second stud retention zone 68 that is axially aligned with the first stud retention zone 58 of the first aperture 56. The second aperture 66 can have a second stud release zone 70 that is axially aligned with the first stud release zone 60 of the first aperture 56. The second aperture 66 can have an elongated shape and can have curved ends resulting in an overall oblong shape as illustrated.

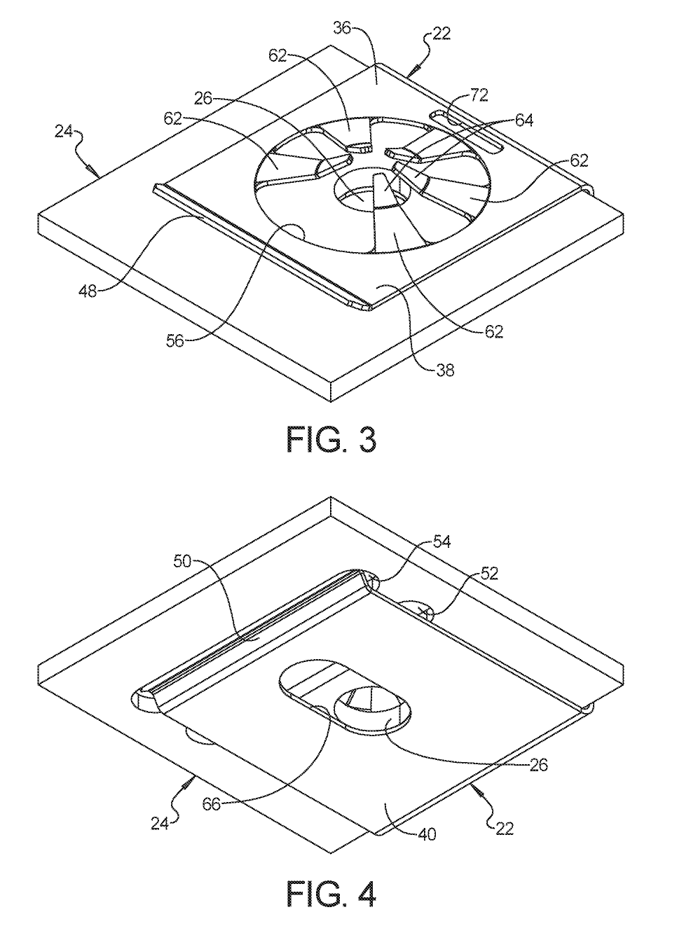

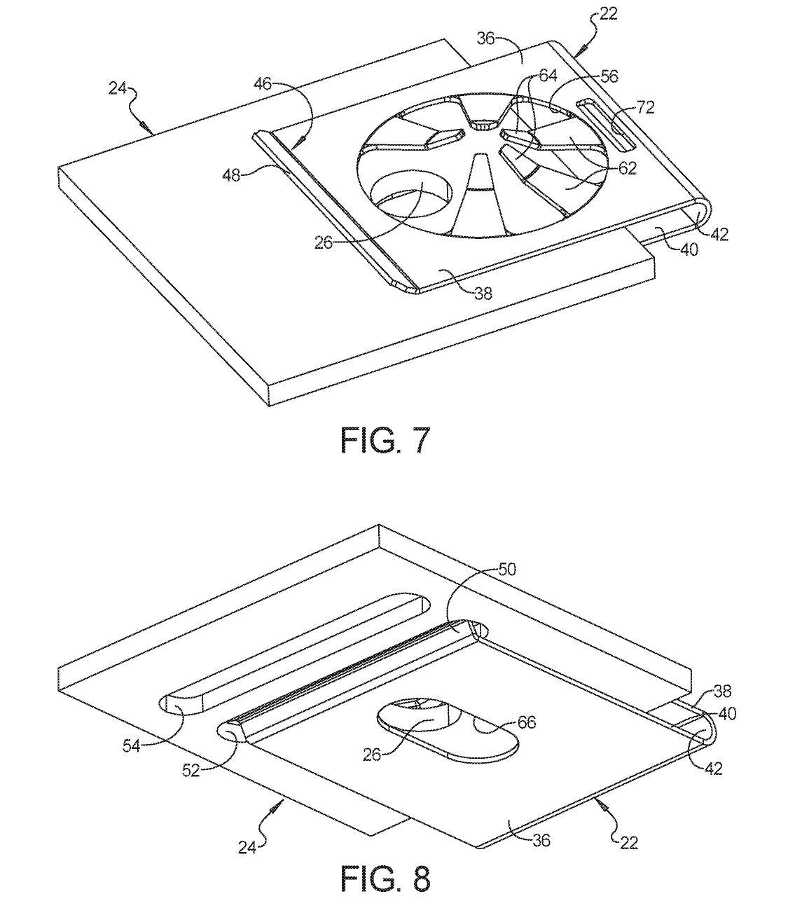

The main body 36 can include a fastener moving recess 72 that is designed to facilitate lateral movement of the fastener 22 relative to the first component 24, when the first component 24 is received in the first component cavity 44, from a retention position (FIGS. 3 and 4) in which the component aperture 26 is axially aligned with the first stud release zone 60 and with the second stud release zone 70, to a release position (FIGS. 7 and 8) in which component aperture 26 is axially aligned with the first stud release zone 60 and with the second stud release zone 70. As in the example fastener 22 of FIGS. 1-ll, the fastener moving recess 72 can be located between the central bend 42 and the first aperture 56. Alternatively, or additionally, the fastener moving recess 72 can be located between the first aperture 56 and the insertion end 46 of the first component cavity 44, as in the example fastener 22 of FIG. 12.

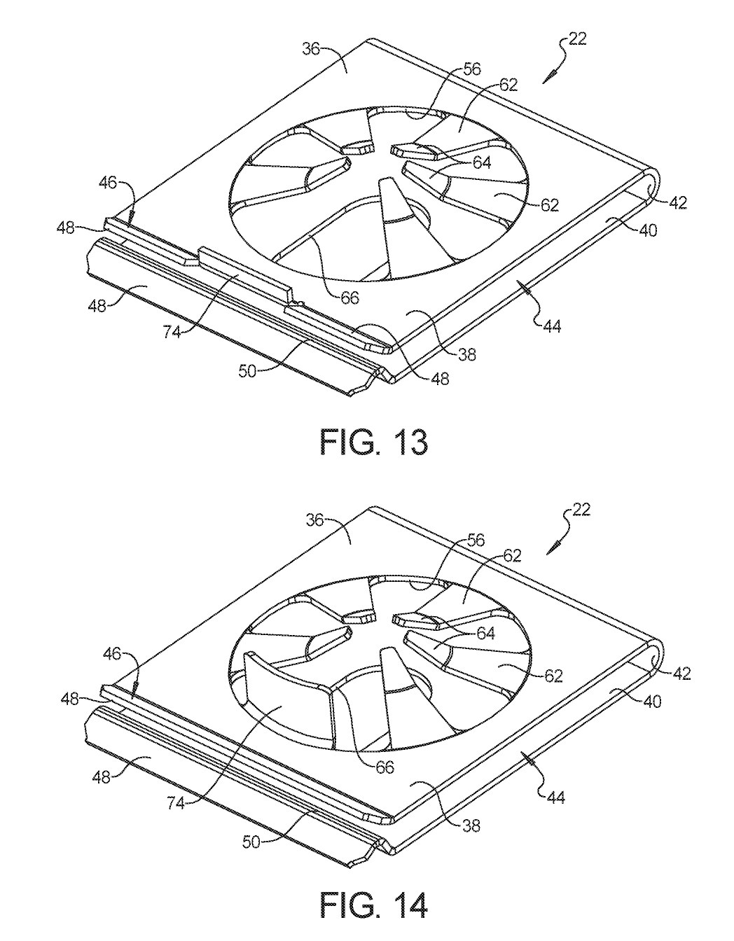

Referring to FIGS. 13 and 14, the main body 36 can include a fastener moving tab 74 that is designed to facilitate lateral movement of the fastener 22 relative to the first component 24, when the first component 24 is received in the first component cavity 44, from a retention position (FIGS. 3 and 4) in which the component aperture 26 is axially aligned with first stud release zone 60 and with the second stud release zone 70, to a release position (FIGS. 7 and 8) in which component aperture 26 is axially aligned with the first stud release zone 60 and with the second stud release zone 70. As in the example fastener 22 of FIG. 13, the fastener moving tab 74 can extend outwardly from an insertion end 46 of the first component cavity 44. Alternatively, or additionally, the fastener moving tab 74 can extend outwardly from the first aperture 56, and can be located between the stud release zone 60 of the first aperture 56 and an insertion end 46 of the first component cavity 44, as in the example fastener 22 of FIG. 14.

The fastener moving tab 74, the spring retention fingers 62, or both can be designed to help insure the parts do not stick together during plating or otherwise tangle or clip to each other. Additional features, such as bumps, ridges, etc., can be added to an outer surface of the second wall 40 to additionally help insure the parts do not stick together during plating or otherwise tangle or clip to each other. The fastener moving tab 74 can also be designed to reduce the load on the fingers during shipping.

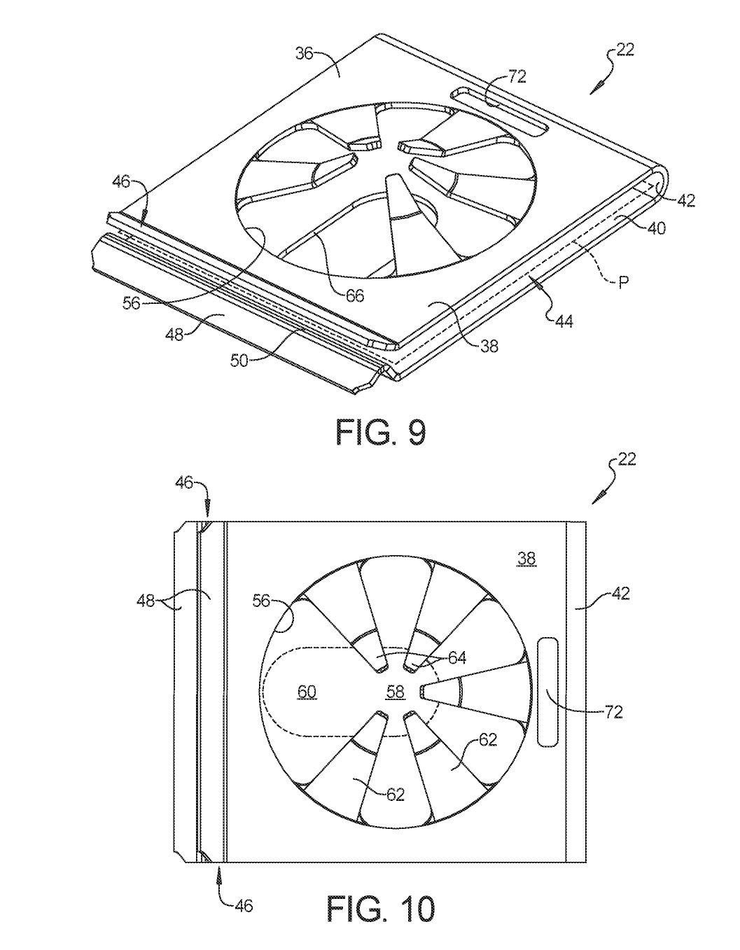

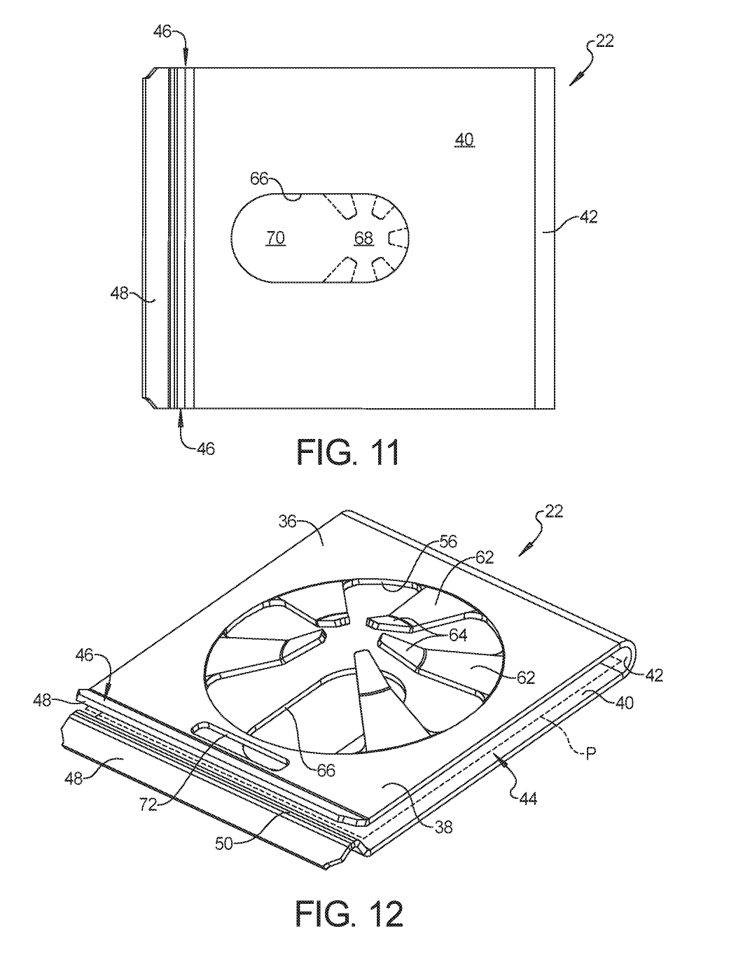

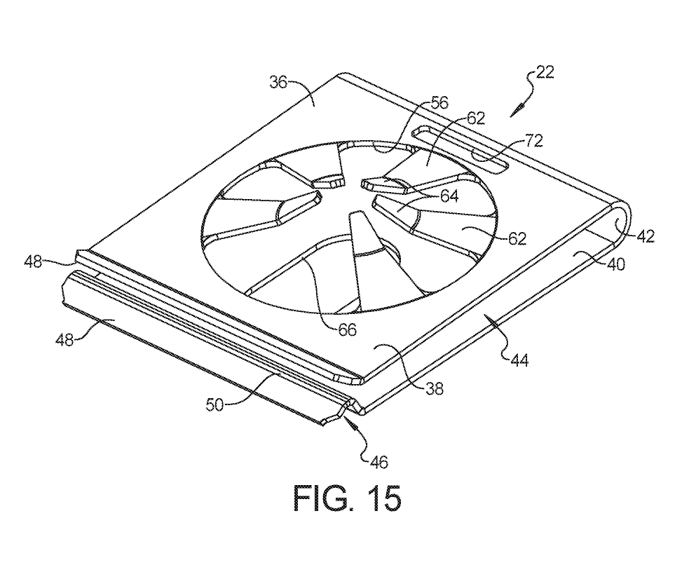

Referring to FIG. 15, the first wall 38 and the second wall 40 can extend can be angled relative to each other. In addition, this angled relative relationship can result in the first wall 38 and the second wall 40 being closer together adjacent the insertion end 46 of the first component cavity 44 than adjacent the central bend 42. In other examples, the angled relative relationship can result in the first wall 38 and the second wall 40 being further away from each other adjacent the insertion end 46 of the first component cavity 44 than adjacent the central bend 42. Alternatively, the first wall 38 and the second wall 40 can extend parallel to each other as seen in FIGS. 9-14.

Referring to FIGS. 3 and 4, the coupling assembly 20 including the removable push-on fastener 22 can be created by inserting the first component 24 into the first component cavity 44 in a lateral direction, or laterally, through the insertion end 46. Engagement of the first component 24 against the outwardly angled surfaces 48 can help spread the insertion end 46 open and facilitate insertion of the first component 24 into the first component cavity 44. The first component 24 can be fully seated in the first component cavity 44 with an edge of the first component 24 against the central bend 42. The removable push-on fastener 22 can be positioned with the first stud retention zone 58 and the second stud retention zone 68 axially aligned with the component aperture 26. The inwardly extending protrusion 50 can be designed to engage with the retention recess 54 of the first component 24 in this retention position to help prevent unwanted movement of the removable push-on fastener 22 relative to the first component 24. This two-part sub-assembly of FIGS. 3 and 4 in the retention configuration can be created at a fastener manufacturing facility or otherwise at a location which is separate from the assembly line where the two components 24, 30 are assembled together. Thus, this retention configuration can correspond to a shipping configuration.

Referring to FIG. 5, the two-part sub-assembly of FIGS. 3 and 4 can then be simply pushed onto the stud 28 extending from the second component 30 in an insertion direction. The stud 28 can pass in the insertion direction into the second stud retention zone 68 of the second aperture 66, then into the component aperture 26 of the first component, and then into the first stud retention zone 58 of the first aperture 56. Thus, the spring retention fingers 62 deflect as they pass each annular protrusion or thread 32. The spring retention fingers 62 can engage the annular protrusions or threads to prevent removal of the stud from the first aperture while the component aperture 26 and the stud 28 are axially aligned with the first and second stud retention zones, 58 and 68, respectively. This can complete the coupling assembly 20 and can couple the first component 24 and the second component 30 together. Thus, assembly of the components 24, 30 together on an assembly line can involve a simple, one-step push-on operation.

Referring to the FIG. 6-8, it may be desirable or necessary to uncouple the components 24, 30 at some point in time. To accomplish this, the removable push-on fastener 22 can be moved laterally relative to the other components. The removable push-on fastener 22 can be positioned with the first stud release zone 60 and the second stud release zone 70 axially aligned with the component aperture 26. The spring retention fingers 62 can be designed to disengage or release the annular protrusions or threads 32 as the component aperture 26 and stud 28 move from axial alignment with the stud retention zones 58, 68 to axial alignment with the stud release zones 60, 70. This movement places the components in a release configuration relative to each other.

To facilitate this movement from the retention configuration into the release configuration, a user can engage the fastener moving recess 72 or the fastener moving tab 74, if present. For example, a user can use a tool, such as a screwdriver, to engage the fastener moving recess 72 or the fastener moving tab 74 and push or pull the removable push-on fastener 22 into the release position and configuration. Alternatively or additionally, a user can directly manually engage the fastener moving recess 72 or the fastener moving tab 74 to push or pull the removable push-on fastener 22 into the release position and configuration.

The inwardly extending protrusion 50 can be designed to engage with the release recess 52 of the first component 24 in this release position to help prevent continued or other unwanted movement of the removable push-on fastener 22 relative to the first component 24. This can reduce or minimize the possibility that the removable push-on fastener 22 will become lost or misplaced while the components 24, 30 are uncoupled from each other. This is a significant advantage over using a threaded nut, which are easily misplaced or lost and are often difficult and time consuming to find or replace.

With the components in this release position and configuration, it is a simple matter to remove the stud 28 from the apertures 26, 56, 66 in an axial stud removal direction that is opposite the stud insertion direction. When it is time to once again re-couple the first component 24 and the second component 30 together, the first component 24 can once again be fully inserted into the component cavity 44 of the removable push-on fastener 22. Thus, the two-piece sub-assembly can be returned to its retention position or configuration, allowing the simple, one-step, push-on coupling process to be repeated.

As previously indicated, the main body 36 completely encloses both the first and second apertures 56, 66. This can provide several meaningful advantages. For example, because the first and second walls 38, 48 are not separated or split along the insertion end 46, it is easier to insert the first component 24 into the component recess 44. This is because there are only two separately moving ends, not three or four. In addition, this meaningfully increases the structural rigidity and integrity of the removable push-on fastener 22. For example, there are no independently movable sides or parts from which the spring retention fingers 62 extend. If there were, the distal ends 64 of the spring retention fingers 62 could move away from each other (e.g., laterally), resulting in the spring retention fingers 62 improperly releasing the protrusions 32. Similarly, the distal ends 64 of the spring retention fingers 62 could move away from each other (e.g., axially) causing them to improperly engage the protrusions 32 resulting in a weak or loose coupling, and one that might fail.

Although the terms first, second, third, etc. may be used herein to describe various elements, components, regions, and/or zones, such numerical terms are only used to distinguish one element, component, region, layer or section from another region, layer or section. Any such numerical terms used herein do not imply any relative importance, sequence or order. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A removable push-on fastener for coupling a first component having a component aperture therethrough with a stud extending from a second component through the component aperture and having at least one annular protrusion along a free end of the stud, the removable push-on fastener comprising:
a U-shaped sheet metal main body having a first wall and a second wall extending from a central bend, forming a first component cavity extending in a plane between the first wall and the second wall;
a first aperture extending through the first wall and the first aperture having a first stud retention zone and a first stud release zone laterally spaced from each other within the first aperture;
a plurality of spring retention fingers extending outwardly from the first wall and into the first aperture, and the spring retention fingers being designed to deflect to pass over the annular protrusion in a stud insertion direction that extends axially, and a distal end of the spring retention fingers being designed to engage the annular protrusion to prevent removal of the stud from the first aperture in a stud removal direction that is opposite the stud insertion direction when the stud is in the stud retention zone, and the spring retention fingers being designed to allow removal of the stud from the first aperture when the stud is in the release zone; and
a second aperture extending through the second wall, and the second aperture having a second stud retention zone axially aligned with the first stud retention zone of the first aperture, and the second aperture having a second stud release zone axially aligned with the first stud release zone of the first aperture;
wherein the main body fully encloses the entire periphery of each of the first aperture and the second aperture.

2. The removable push-on fastener of claim 1, wherein the first wall of the main body fully encloses the first aperture, and wherein the second wall of the main body fully encloses the second aperture.

3. The removable push-on fastener of claim 1, wherein the spacing between an adjacent pair of the spring retention fingers that is across the first stud release zone from each other is greater than each corresponding spacing between each remaining adjacent pair of spring retention fingers.

4. The removable push-on fastener of claim 1, wherein spacing between an adjacent pair of spring retention fingers that is across the first stud release zone from each other is twice that of a common corresponding spacing between each remaining adjacent pair of spring retention fingers.

5. The removable push-on fastener of claim 1, wherein the spring retention fingers number five and the spacing between an adjacent pair of spring retention fingers that is across the first stud release zone from each other can be 120 degrees, and a common corresponding spacing between each remaining pair of adjacent pair of the spring retention fingers is 60 degrees.

6. The removable push-on fastener of claim 1, wherein the main body includes a fastener moving recess designed to facilitate lateral movement of the fastener relative to the first component, when the first component is received in the first component cavity, from a retention position in which the component aperture is axially aligned with the first and second stud retention zones to a release position in which component aperture is axially aligned with the first and second stud release zones.

7. The removable push-on fastener of claim 6, wherein the fastener moving recess is located between the central bend and one of the first and second apertures.

8. The removable push-on fastener of claim 6, wherein the fastener moving recess is located between an insertion end of the first component cavity and the first aperture.

9. The removable push-on fastener of claim 1, wherein the main body further comprises a fastener moving tab designed to facilitate lateral movement of the fastener relative to the first component, when the first component is received in the first component cavity, from a retention position in which the component aperture is axially aligned with the first and second stud retention zones to a release position in which component aperture is axially aligned with the first and second stud release zones.

10. The removable push-on fastener of claim 9, wherein the fastener moving tab extends outwardly from an insertion end of the first component cavity.

11. The removable push-on fastener of claim 10, wherein the fastener moving tab extends axially.

12. The removable push-on fastener of claim 9, wherein the fastener moving tab extends outwardly from the first aperture.

13. The removable push-on fastener of claim 12, wherein the fastener moving tab is located between the stud release zone and an insertion end of the first component cavity.

14. The removable push-on fastener of claim 13, wherein the fastener moving tab extends axially.

15. The removable push-on fastener of claim 1, wherein the first wall and the second wall of the main body extend parallel to each other.

16. The removable push-on fastener of claim 1, wherein the first wall and the second wall of the main body are angled relative to each other to be closer together adjacent an insertion end than adjacent the central bend.

17. The removable push-on fastener of claim 1, wherein the main body includes an inwardly extending protrusion designed to engage with a release recess of the first component when the first component is received in the first component cavity in a release position in which the component aperture is aligned with the first and second stud release zones.

18. The removable push-on fastener of claim 1, wherein the main body includes an inwardly extending protrusion designed to engage with a retention recess of the first component when the first component is received in the first component cavity in a retention position in which the component aperture is aligned with the first and second stud retention zones.

19. The removable push-on fastener of claim 18, wherein the protrusion is adjacent an insertion end of the first component cavity.

20. The removable push-on fastener of claim 1, wherein the main body includes at least one outwardly angled surface at an insertion end opposite the central bend and designed to facilitate insertion of the first component into the first component cavity through the insertion end.

21. The removable push-on fastener of claim 1, wherein each of the first and second walls of the main body include an outwardly angled surface at an insertion end opposite the central bend and designed to facilitate insertion of the first component into the first component cavity through the insertion end.

22. The removable push-on fastener of claim 1, wherein the main body includes an inwardly extending protrusion designed to engage with a release recess of the first component when the first component is received in the first component cavity in a release position in which the component aperture is aligned with the first and second stud release zones, and to engage with a retention recess of the first component when the first component is received in the first component cavity in a retention position in which the component aperture is aligned with the first and second stud retention zones, and wherein an outwardly angled surface extends from the inwardly extending protrusion at an insertion end opposite the central bend, which outwardly angled surface is designed to facilitate insertion of the first component into the first component cavity through the insertion end.

23. The removable push-on fastener of claim 1, wherein the spring retention fingers are designed to pass over and engage with the at least one protrusion in the form of a series of annular protrusions.

24. The removable push-on fastener of claim 1, wherein the spring retention fingers are designed to pass over and engage with the at least one protrusion in the form of a series of annular protrusions provided by screw threads.
